(19) United States
(12) Patent Application Publication
(10) Pub. No.: US 2025/0284989 A1
(43) Pub. Date: Sep. 11, 2025

(54) QUANTUM MIRROR MODE FOR ARTIFICIAL INTELLIGENCE (AI) MODELS

(71) Applicant: Bank of America Corporation, Charlotte, NC (US)

(72) Inventor: George Albero, Charlotte, NC (US)

(21) Appl. No.: 18/600,843

(22) Filed: Mar. 11, 2024

(51) Int. Cl. G06N 10/20; G06N 10/60; G06N 20/00

(52) U.S. Cl. CPC G06N 10/20; G06N 10/60; G06N 20/00

(57) ABSTRACT

Systems, methods, and apparatus are provided for remediating an AI hallucination using a quantum processor. A data stream may be received, and an AI-based operation executed. In mirror mode, the data stream may be mirrored, and a mirrored AI-based operation executed. A continuous hashing algorithm may hash output from the AI-based operation and output from the mirrored AI-based operation. When the hashes are not identical, output from the mirrored AI-based operation may be deleted. The AI-based operation may be terminated and reinitiated at the last point the hashes are identical. Output from the AI-based operation may be mirrored at the point that the search is reinitiated. In mirror mode, the quantum processor may be automatically scaled by adding quantum circuits to a quantum thread when a task has a duration that is longer than a threshold duration and/or a volume that is greater than a threshold volume.

### FIELD OF TECHNOLOGY

Aspects of the disclosure relate to using quantum computing systems to redirect AI models in real time.

### BACKGROUND OF THE DISCLOSURE

Quantum computing systems provide tremendous advantages over standard data processing and storage. In standard computing, bits hold only one of two values and the number of states is limited. In quantum computing, entangled qubits may hold all possible values at the same time, enabling many more states. As such, quantum computers may work much faster and handle much more data than standard computers.

Generative artificial intelligence (AI) models may include large language model (LLM) chatbots that are trained using transformer-based deep neural networks. These models may be trained to predict strings of words or images that best match a request. Generative AI models may accept a natural language request as input and output generated content.

One risk associated with generative AI models is AI hallucination. The model may generate false or misleading information and present it as fact. The model may find patterns or objects that are nonexistent and create outputs that are incorrect.

Conventional systems may attempt to minimize AI hallucinations by limiting the model, restricting the input data sets, using data templates, or regularly reviewing the system. However, none of these approaches are able to detect or mitigate an AI hallucination output in real time. It would be desirable to use the enhanced technical capabilities of a quantum computing system to identify AI hallucinations and redirect the model to remediate an incorrect output.

### SUMMARY OF THE DISCLOSURE

Systems, methods, and apparatus are provided for remediating AI hallucinations using a quantum computing system.

A data stream may be received from a user and an AI-based operation may be executed. A quantum processor may initiate a mirror mode. In the mirror mode, the quantum processor may mirror the data stream and execute a mirrored AI-based operation. The AI-based operation may generate a first output and the mirrored AI-based operation may generate a second output.

The mirror mode may include a continuous hashing algorithm. The hashing algorithm may generate hashes from the first output and hashes from the second output. The quantum processor may determine whether a hash of the first output is identical to a hash of the second output.

When the hashes of the outputs are not identical, the AI-based operation may be paused, and the second output may be deleted. The AI-based operation may be resumed from the last point that the hashes of the outputs were identical. The quantum processor may mirror the first output at this timestamp and execute a mirrored AI-based operation from this inception point.

A quantum circuit at the quantum processor may be initialized to operate the hashing algorithm. When the AI-based operation is complete, the quantum circuit may be collapsed. The quantum processor may have N qubits, where N is a number between two and ten thousand. The continuous hashing algorithm may utilize a superposition property of the N-qubit processor.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows illustrative apparatus in accordance with principles of the disclosure;

FIG. 2 shows illustrative apparatus in accordance with principles of the disclosure;

FIG. 3 shows an illustrative diagram in accordance with principles of the disclosure;

FIG. 4 shows an illustrative diagram in accordance with principles of the disclosure;

FIGS. 5A and 5B show illustrative diagrams in accordance with the principles of the disclosure;

FIG. 6 shows an illustrative diagram in accordance with the principles of the disclosure;

FIG. 7 shows an illustrative process flow in accordance with the principles of the disclosure; and

FIG. 8 shows an illustrative process flow in accordance with the principles of the disclosure.

### DETAILED DESCRIPTION

Systems, methods, and apparatus are provided for remediating AI hallucinations using a quantum computing system.

For the sake of illustration, the invention will be described as being performed by a “system.” The system may include one or more features of apparatus and methods that are described herein and/or any other suitable device or approach.

The system may include a standard (i.e., non-quantum) processor. The system may include a quantum processor. A quantum processor may be used herein to refer to a computing device whose operations can harness aspects of quantum mechanics, such as superposition, interference, and entanglement.

Quantum processors are associated with vastly improved efficiencies over standard computers. Standard computers represent data in bits, which can be either 0 or 1. Quantum processors use qubits which utilize superposition (i.e., the ability to be in multiple states at the same time) to allow for a state of 0, 1, or any probability of being 0 or 1. The probabilities may be manipulated using matrix-based quantum gates, which are analogous to standard logic gates. Qubits are therefore able to represent many more data possibilities than a bit-based system of the same size. This allows for greater speed and less memory usage than standard systems.

A qubit in a state of superposition may not have a defined value because it may hold many potential values at the same time. When measured, the qubit wave function collapses to a defined state. When an entangled qubit is in a state of superposition, each of its entangled connections is also in a state of superposition. These combinations of uncertainties exponentially increase the power of quantum processors.

The quantum processor may include a default number of quantum threads. Each quantum thread may include a default number of quantum circuits. Quantum circuits may refer to hardware and software based computational models that include quantum gates and are used for executing quantum computations.

In some embodiments, at least one of the quantum circuits may include a Toffoli gate. A feature of the Toffoli gate is its universal nature, meaning the structure is able to represent standard operations as well as quantum operations. In some embodiments, at least one of the quantum circuits may include a Hadamard gate. A feature of the Hadamard gate is the ability to represent a superposition state.

Quantum computing may be referred to as the use of quantum-mechanical phenomena such as superposition and entanglement to perform computations. The smallest bit in a quantum computer may be called a “qubit.”

Executable instructions may be executed by an “N”-qubit processor on a computer system. “N” may be a number between two and ten thousand.

The amount of data that a quantum computer may be able to hold and manipulate may grow exponentially with the number of qubits included in the quantum computer's processing core. A quantum computer with “N” qubits may be able to simultaneously represent 2N states. Therefore, two qubits may hold four states, three qubits may hold eight states, fifty qubits may hold 1,125,899,906,842,624 states, and 10,000 qubits may hold 210000 states.

Other standard components of a computer system may be present, such as communication links, displays, input and output devices, read-only and random-access memory, and other components.

The term “non-transitory memory,” as used in this disclosure, is a limitation of the medium itself, i.e., it is a tangible medium and not a signal, as opposed to a limitation on data storage types (e.g., RAM VS. ROM). “Non-transitory memory” may include both RAM and ROM, as well as other types of memory.

The non-transitory memory may be configured to store executable data configured to run on the “N”-qubit processor and/or a standard processor.

The “N”-qubit processor or standard processors may control the operation of the computer system and its components, which may include RAM, ROM, an input/output module, and other memory. Standard microprocessors or standard processors may refer to non-qubit processors.

Other components commonly used for computers, such as EEPROM or Flash memory or any other suitable components, may also be part of the apparatus and computer system.

A communication link may enable communication with other computers and servers, as well as enable the program to communicate with databases. The communication link may include any necessary hardware (e.g., antennae) and software to control the link. Any appropriate communication link may be used, such as Wi-Fi, Bluetooth, LAN, and cellular links. Multiple communication links may be present. In some embodiments, the network used to communicate may be the Internet. In some embodiments, the network may be an internal intranet or other internal network.

Generative AI is artificial intelligence technology that produces various types of content, including text, images, audio, and synthetic data. In some instances, the AI algorithms may produce incorrect results that are not based on training data or are incorrectly decoded by a transformer model. The AI algorithm may present these incorrect results as fact, a phenomenon known as AI hallucination.

AI models may also produce false information in response to an attack by a bad actor. For example, a bad actor may manipulate the output of an AI model by subtly adjusting the input data. For image recognition algorithms, an adversarial attack might involve adding a small amount of noise to an image, causing the AI model to misclassify it.

The system may use a quantum processor in a continuous or substantially continuous mirror mode to identify and correct AI hallucinations.

Data mirroring refers to generating an exact copy of a data set in real time. Data mirroring may involve copying the data from one location to a local or remote storage medium. Data mirroring may involve copying the data to different partitions of the same disk or to separate disks within the same system. When each system has a separate hard drive controller card, the process may be known as disk duplexing.

The quantum processor may activate a mirror mode. In the mirror mode, the quantum processor may mirror a data stream and execute a mirrored AI-based operation based on the mirrored data stream. In some embodiments, the system may generate more than one mirrored copy of the data stream.

The system may monitor the output returned for each mirrored copy of the data stream. In the mirror mode, the quantum processor may continuously or substantially continuously hash the output for the original AI-based operation and the outputs for each mirrored AI-based operation. The quantum processor may compare the hash values. The enhanced speed and capacity of quantum computing may enable continuous hashing for both the original operation and the mirrored operation and continuous comparisons between the hash values.

The comparison of hash values may confirm the integrity and consistency of the output from the AI-based operation. If the hash values are identical, the underlying data may be assumed to be identical as well. If the hash values are not identical, the underlying data may be assumed to diverge.

An AI hallucination in the AI-based operation may cause a mismatch between the hashes. In response to detection of the mismatch, the system may take steps to remediate the hallucination.

The system may return the AI-based operation to the inception point of the hallucination. The inception point may be identified as the last time the hash values are identical. The inception point may be identified by a timestamp associated with the AI-based operation.

The system may create a new mirrored copy of the output from the AI-based operation starting at this inception point. The system may enable the AI-based operation to proceed from this inception point. In some embodiments, the system may terminate the AI-based operation and reinitiate the operation at the inception point. In some embodiments, the system may pause the AI-based operation and resume the operation from the inception point.

The AI-based operation may be a search, a computation, a machine learning operation, process automation or any suitable AI-based operation. In an AI search, the system may receive a prompt from a user, from a computer application, or from any suitable source. The prompt may be a user query. The system may mirror the query and execute a mirrored AI search. Quantum-based operations in the mirror mode may confirm the integrity of the AI search results.

Another issue that may cause generative AI tools to generate misleading results is excessive branching. Branching refers to adding new child nodes to a search tree. Horizontal branching may expand options at the same level and vertical branching may expand options at deeper levels.

A branching factor parameter may be associated with the AI-based. The branching factor may determine the number of permitted nodes. For example, AI-based natural language processing may involve parsing sentences. The branching factor may dictate the number of possible grammatical structures for a sentence.

A high branching factor may allow AI algorithms to explore diverse options and consider a broader range of possibilities. However, high branching factors may require significant memory and processing power which may slow down the system. In some cases, a very high branching factor can lead to excessive exploration which may take the search off-track and return inaccurate results.

In some embodiments, the quantum processor may analyze the branches at predetermined points. The predetermined points may be at regular time intervals or random time intervals. In some embodiments, the quantum processor may analyze the branches when the branching exceeds a branching factor.

Based on branch content and/or the original data stream, the quantum processor may identify the branches most likely to output accurate results. The system may select a set of branches to continue. The system may terminate the remaining branches that are not selected. The system may mirror the output at this point for each branch that is allowed to continue.

In some embodiments, the quantum processor may analyze the branches in response to a mismatch between the hashes. Excessive branching in the AI-based operation may cause a mismatch between the hashes. In response to detection of the mismatch, the system may return the AI-based operation to the inception point of the excessive branching. The inception point may be identified as the last time the hash values are identical. The quantum processor may analyze the branches at the inception point. Based on branch content and/or the original data stream, the quantum processor may identify the branches most likely to output accurate results. The system may select a set of branches to continue. The system may terminate the remaining branches that are not selected. The system may mirror the output at the inception point for each branch that is allowed to continue.

In response to identification of a mismatch and/or an inception point, the system may delete all data from the mirrored AI-based operation. At the inception point, the system may mirror the output from the AI-based operation to create a new copy and execute a new mirrored AI-based operation. Deleting all data from the mirrored operation following each mismatch reduces the burden on system memory.

In a quantum computing system, the enhanced speed and capacity may enable substantially continuous hashing of both the original AI-based operation and the mirrored operations. The quantum computing system may include multi-dimensional scaling. The data stream may be routed to a quantum processor having a default number of quantum threads. Each quantum thread may include a default number of quantum circuits.

The system may automatically scale the quantum processor during a mirror mode operation. The scaling may include adding additional quantum circuits to each quantum thread when a task is detected to have a duration that is longer than a threshold duration. The scaling may include adding additional quantum threads when a task is detected to have a volume that is larger than a threshold volume.

Determination of the inception point, determination of the number of copies, identification of likely branches, scaling of the quantum processor, and/or any suitable operations may be carried out by one or more artificial intelligence/machine learning (AI/ML) algorithms.

A mirror mode operation may initiate a quantum circuit. A quantum circuit may include one or more qubits and quantum gates. A group of qubits may be referred to as a quantum register. The quantum gates may perform operations that manipulate the quantum states of the qubits.

In the mirror mode, the quantum processor may simultaneously analyze each mirrored operation with its assigned qubits. The analysis may be carried out by any suitable algorithm or algorithms including one or more algorithms that use qubit superposition and entanglement properties.

Mirror mode operations may generate outputs that include hash values, hash value comparisons, identification of inception points, number of mirrored copies, number of branches and/or any suitable outputs. The outputs may be a result of “viewing” or “measuring” the qubits or quantum registers, collapsing a quantum probability into a discrete output (generally 0 or 1). This viewing or measuring may take place multiple times per second. The output may be digital data. The output may be displayed on a graphical user interface. The output may be transmitted to a different computer or a different part of the computer system for further analysis or computations.

Mirror mode operations may compare hashes from every mirrored operation to the original operation and to every other mirrored operation. For example, the analysis may include comparing a first hash of AI-based search data to a second hash of AI-based search data. A qubit-based processor may compare the data exponentially faster than a standard microprocessor.

In some embodiments, the system may include instructions executed by a standard (non-qubit) processor on a computer system. The computer system may be the same computer system as the quantum processor. The standard processor may manage quantum processor operations through one or more AI/ML algorithms. Managing may include directing mirroring of operation data, selecting a hashing algorithm to apply to the operation data, efficiently running the quantum processor, analyzing the outputs, and/or any other suitable function.

An AI/ML manager of the quantum-based analysis may be necessary as the outputs may be too large or come too fast for a human operator to manage efficiently. The AI/ML algorithms may be trained using simulated training data or real world data. The AI/ML algorithms may be trained on the output iteratively. The AI/ML algorithms may be suitable for quantum processors.

In some embodiments, the quantum processor may include one or more Toffoli gates, Hadamard gates, and/or any suitable quantum logic gate.

One or more non-transitory computer-readable media storing computer-executable instructions are provided. When executed by a processor on a computer system, the instructions may perform a method for remediating an AI hallucination at a quantum processor in a quantum information system.

The method may include receiving a query from a user and executing an AI-based search. The AI search may return AI search data. The method may include activating a mirror mode on a quantum processor. The mirror mode may mirror the AI query and execute a mirrored AI-based search. The mirrored AI-based search may return mirrored AI search data.

The method may include, at a series of timestamps, generating a first hash from the AI search data and a second hash from the mirrored AI search data. The method may include determining whether the first hash and the second hash are identical. When the hashes are not identical, the method may include terminating the AI search and purging the mirrored AI search.

The method may include identifying the latest timestamp when the hashes are identical and reinitiating the AI search from the latest timestamp. The method may include generating a new mirrored copy of the AI search data at the latest timestamp.

The computer system may include both a standard processor and a quantum processor. The method may include receiving the query at the standard processor. The method may include initializing a quantum circuit at the quantum processor and operating a hashing algorithm at the quantum circuit. The hashing algorithm may continuously hash the AI search data and the mirrored AI search data for the duration of the AI-based search. When the AI-based search is complete, the method may include collapsing the quantum circuit. The quantum processor may have N qubits, where N is a number between two and ten thousand. The continuous hashing algorithm may utilize a superposition property of the N-qubit processor.

The method may include using one or more AI/ML algorithms to determine whether the hashes were identical. The method may include using one or more AI/ML algorithms to identify the last point when the hashes are identical.

In some embodiments, the hashes may be compared at a series of timestamps. Intervals in the series of timestamps may be determined based on user input. Intervals in the series of timestamps may be determined by one or more AI/ML algorithms. Intervals between the timestamps may be reduced so that the hashing is substantially continuous. For example, hashes may be computed millions of times per second.

The method may include, when the hashes are not identical, applying the AI search data to train the AI search algorithm.

In some embodiments, the method may include generating more than one mirrored copy of the query and executing multiple mirrored AI searches.

In some embodiments, the hashes may not be identical due to branching that exceeds a branching factor. The latest timestamp may include a plurality of branches. The method may include selecting a set of branches from the plurality of branches based on analysis of the branch content and the query. The method may include mirroring the search data for each branch in the set of branches before reinitiating the search.

The quantum processor may include a default number of quantum threads. Each quantum thread may include a default number of quantum circuits. The method may include automatically scaling the quantum processor in the mirror mode. The method may include adding quantum circuits to each quantum thread when a processing task is detected to have a duration that is longer than a threshold duration. The method may include adding quantum threads when the processing task is detected to have a volume that is larger than a threshold volume.

Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods. Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

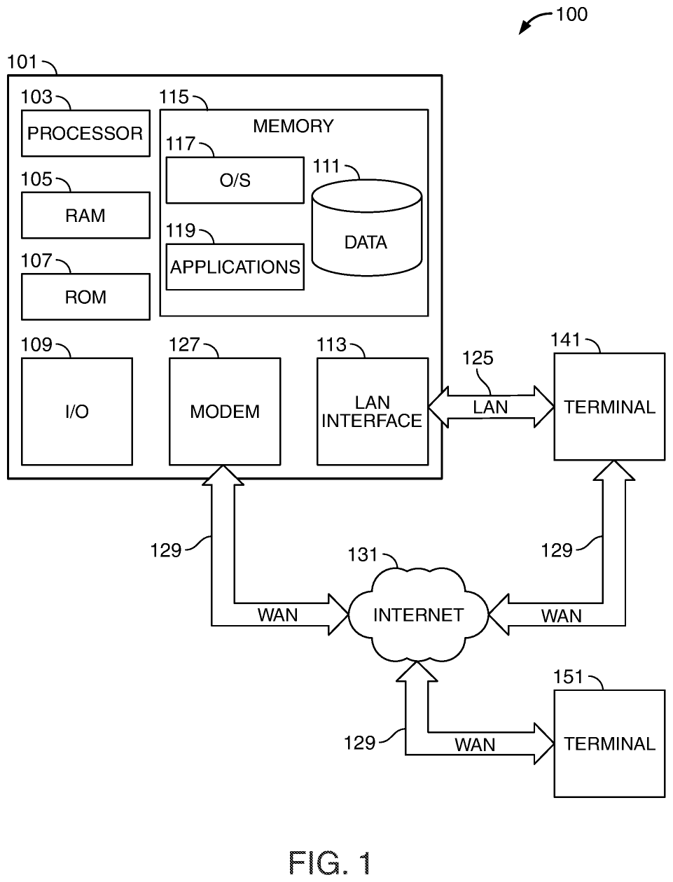

FIG. 1 shows an illustrative block diagram of system 100 that includes computer 101. Computer 101 may alternatively be referred to herein as an “engine,” “server,” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all of the elements and apparatus of system 100.

Computer 101 may include processor 103 for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components commonly used for computers, such as EEPROM or flash memory or any other suitable components, may also be part of computer 101.

Memory 115 may include any suitable permanent storage technology, such as a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113. System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129 but may also include other networks. When used in a LAN networking environment, computer 101 may connect to LAN 125 through LAN interface 113 or an adapter. When used in a WAN networking environment, computer 101 may include modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit retrieval of data from a web-based server or application programming interface (API). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks. Application program(s) 119 may utilize one or more decisioning processes for mirror mode operations as described herein.

The invention may be described in the context of computer-executable instructions, such application(s) 119, being executed by a computer. Generally, programs include routines, programs, objects, components, data structures, etc., that perform particular tasks or implement particular data types. The invention may also be practiced in distributed computing environments where tasks are performed by remote processing devices that are linked through a communications network. In a distributed computing environment, programs may be located in both local and remote computer storage media including memory storage devices. It should be noted that such programs may be considered, for the purposes of this application, as engines with respect to the performance of the particular tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. The differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCS, minicomputers, mainframe computers, distributed computing environments that include any of the above systems or devices, and the like.

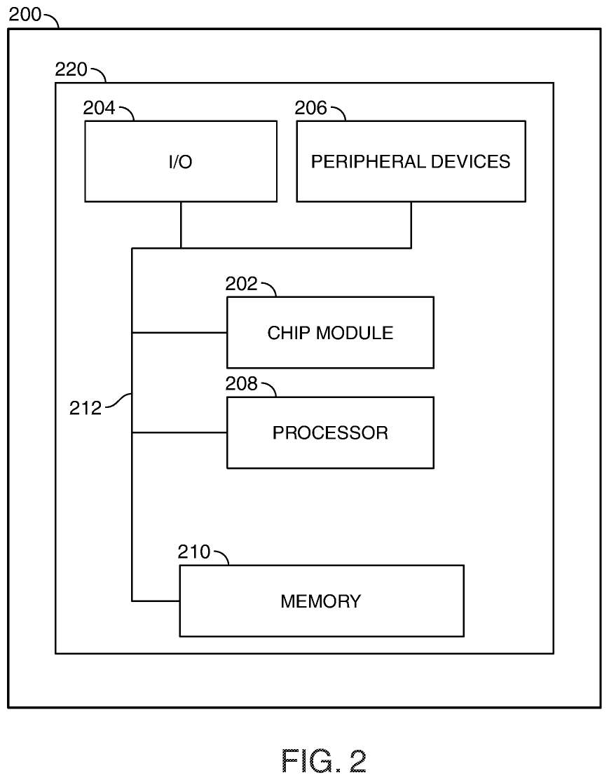

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, which may include one or more integrated circuits, and which may include logic configured to perform any suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 219, signals, and/or any other suitable information or data structures.

Components 202, 204, 206, 208, and 210 may be coupled together by a system bus or other interconnections 212 and may be present on one or more circuit boards such as circuit board 220. In some embodiments, the components may be integrated into a single chip. The chip may be silicon-based.

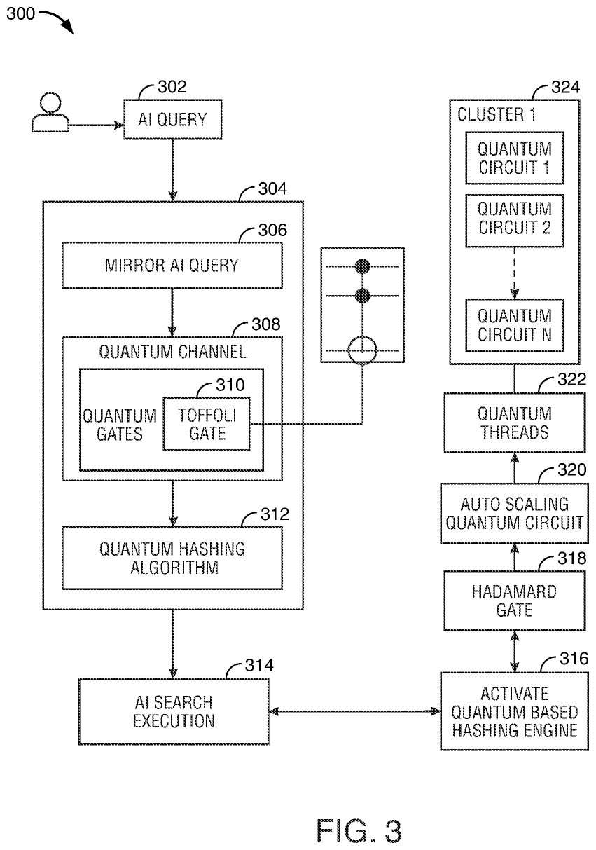

FIG. 3 shows illustrative diagram 300 in accordance with principles of the disclosure. Diagram 300 shows architecture and process steps of a quantum computing powered system with multi-dimensional scaling for remediating an AI hallucination. Diagram 300 shows an AI-based search operation, but the architecture and process may be applied to any suitable AI-based operation.

A query may be received by an AI interface at 302. At 304 mirror mode may be activated. In mirror mode 304, the system may duplicate the query for a parallel AI search. Mirror mode 304 may route the AI search data to quantum channel 308, which may include Toffoli gate 310. The system may select quantum hashing algorithm 312. The system may execute the query at 314, at quantum processor 316.

The quantum processor may include Hadamard gate 318. The quantum processor may include automatic scaling 320, wherein the processor may be initialized with a default size that may include a number of quantum threads 322, each thread including a cluster of quantum circuits 324. The scaling may include dynamically adjusting the number of threads and/or circuits based on the present computing task.

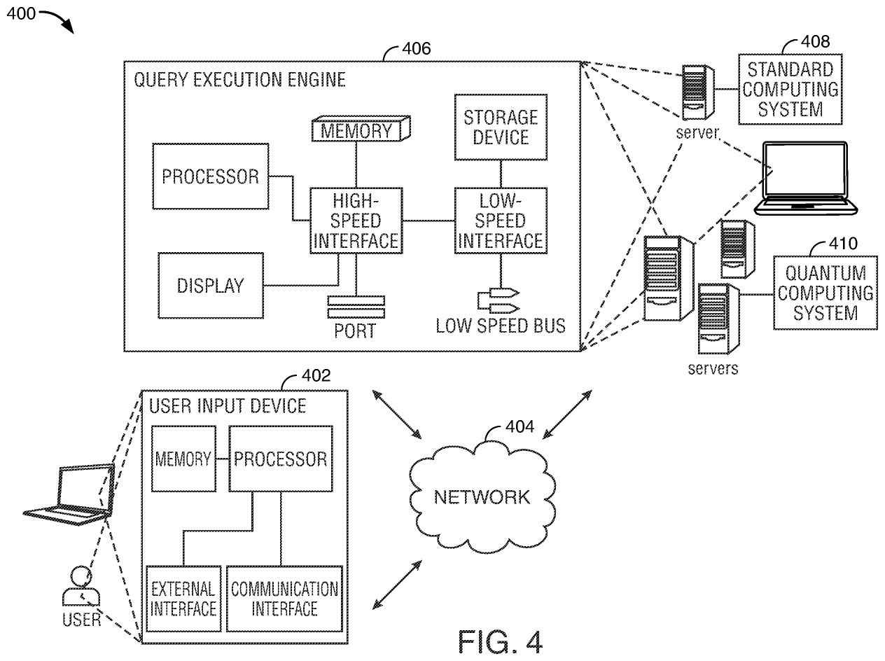

FIG. 4 shows illustrative architecture diagram 400 in accordance with principles of the disclosure. Diagram 400 relates to an AI-based search operation, but the architecture may be applied to any suitable AI-based operation.

Diagram 400 includes user input device 402 and query execution engine 406, some or all of which may be in communication with each other via network 404.

User input device 402 may include a memory, processor, external interface, and communication interface. Execution engine 406 may include a processor, a display, memory, high-speed and low-speed interfaces, connection ports, and suitable memory devices and communication busses. The system may include standard computing system 408 and quantum computing system 410, which may execute queries and various computing tasks according to the methods and configurations disclosed herein.

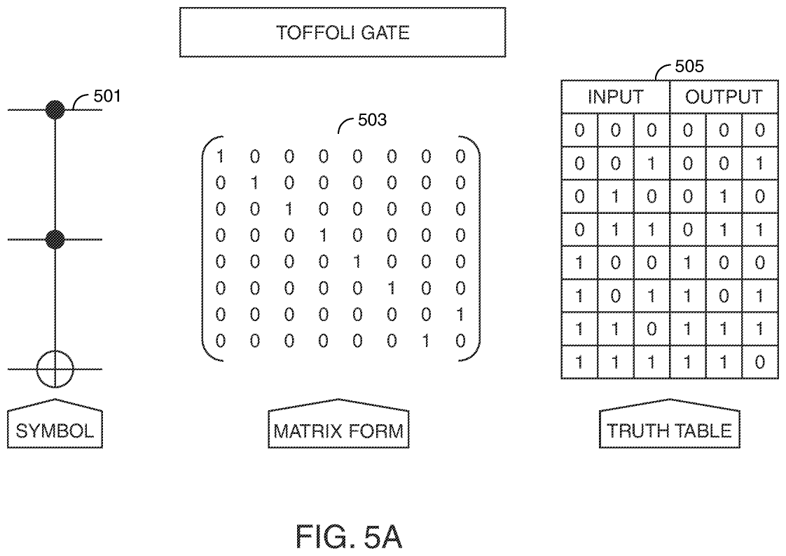

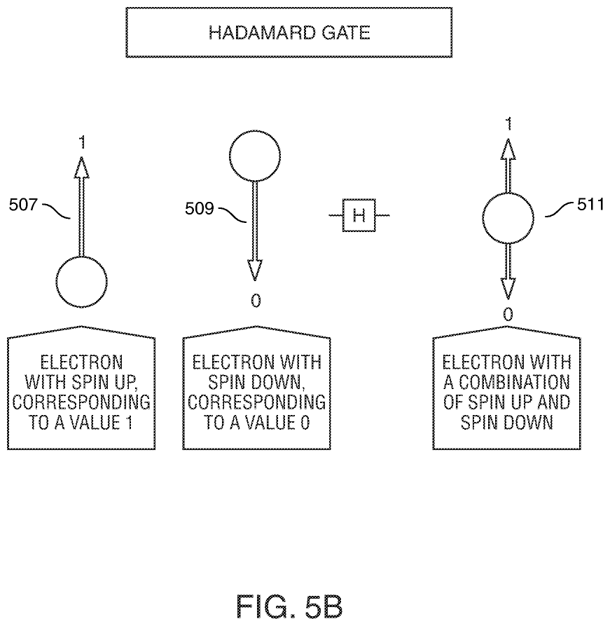

FIGS. 5A-5B show illustrative diagrams of exemplary quantum gates in accordance with principles of the disclosure.

FIG. 5A shows symbol 501, matrix form 503, and truth table 505 of a Toffoli gate. A Toffoli gate is a universal reversible logic gate, which means that it enables simulation of any standard reversible circuit. In operation, as seen in truth table 505, the Toffoli gate has a 3-bit input and a 3-bit outputs. The first two output bits always mirror the first two input bits. The third bit also stays the same unless the first two input bits are both set to 1-in which case the third output bit is inverted from the third input bit. The Toffoli gate is therefore also known as the “controlled-controlled-not” gate.

FIG. 5B shows representations of a Hadamard gate. Symbol 507 shows a representation of electron spin up, which corresponds to the value 1. Symbol 509 shows a representation of electron spin down, which corresponds to the value 0. Symbol 511 shows a representation of electron spin up and down, which corresponds to the value that represents a superposition of 1 and 0.

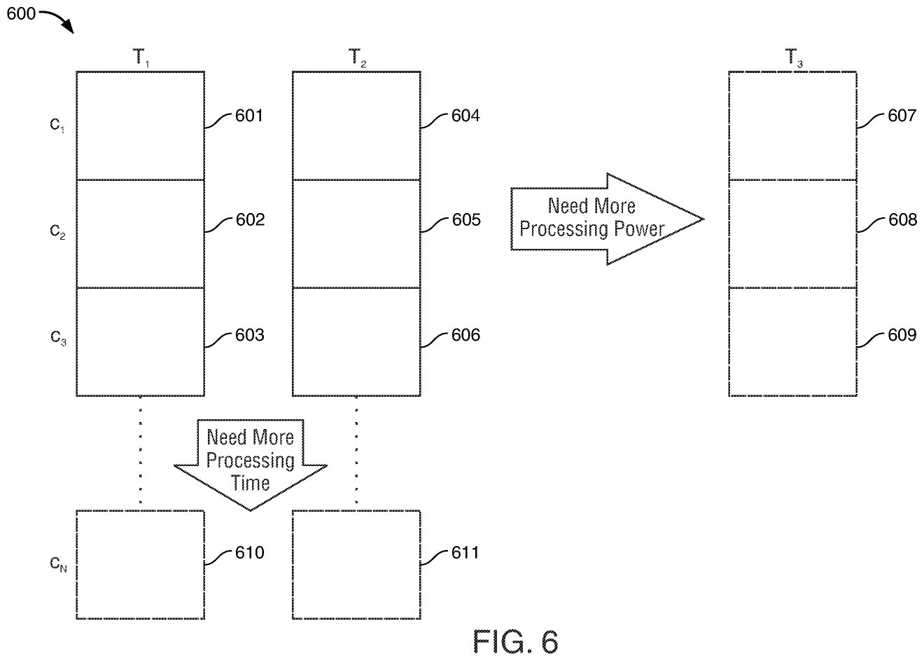

FIG. 6 shows illustrative diagram 600 in accordance with principles of the disclosure. Diagram 600 shows scaling of a quantum processor as disclosed herein. In an illustrative default initialization, the quantum processor may include a first quantum thread T1 that includes quantum circuits 601-603 and a second quantum thread T2 that includes quantum circuits 604-606. When the system detects a need for more processing power, a third quantum thread T3 may be added which may include quantum circuits 607-609. When the system detects a need for more processing time, quantum circuits 610 and 611 may be added to existing threads T1 and T2.

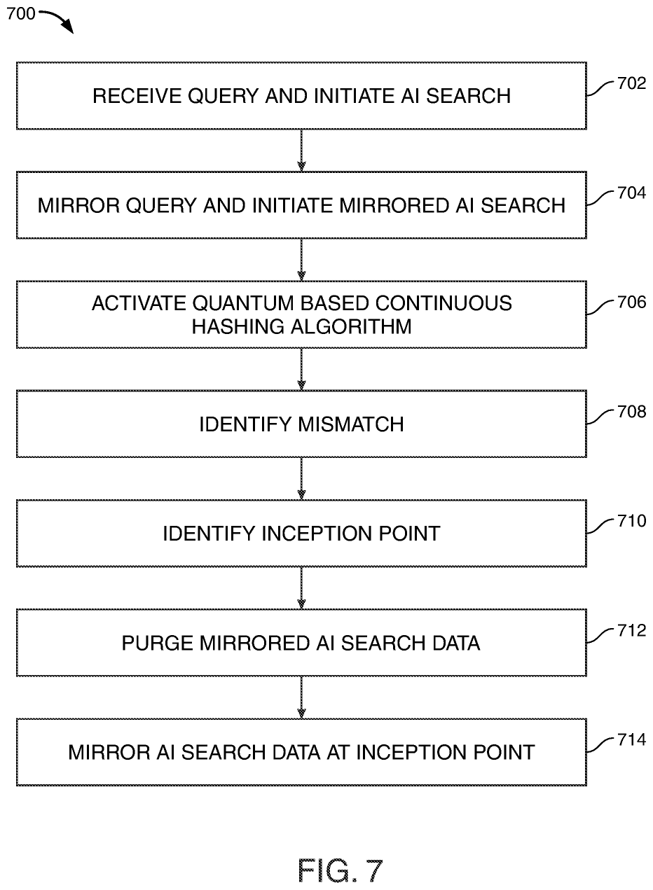

FIG. 7 shows illustrative process flow 700 for remediating an AI hallucination. Process flow 700 shows a hallucination from an AI-based search operation, but the steps may be applied to any suitable AI-based operation.

At 702, the system may receive a query at an AI search interface and process the query to initiate an AI search. At 704, the system may activate a mirror mode. In the mirror mode, the system may duplicate the query and initiate a mirrored AI search. In some embodiments, the system may receive the AI query at a standard processor and activate the mirror mode at a quantum processor.

At 706, the system may activate a continuous hashing algorithm. The hashing algorithm may be quantum based. The hashing algorithm may substantially continuously hash the AI search data and the mirrored AI search data and compare the hash values. In some embodiments, the system may activate the mirror mode at a standard processor and activate the continuous hashing algorithm at a quantum processor. At 708, the system may identify a mismatch between the hashes.

At 710, the system may identify an inception point. The inception point may be the last timestamp during the search when the hashes were identical. At 712, the system may purge the mirrored AI search data. At 714, the system may mirror the AI search data at the inception point.

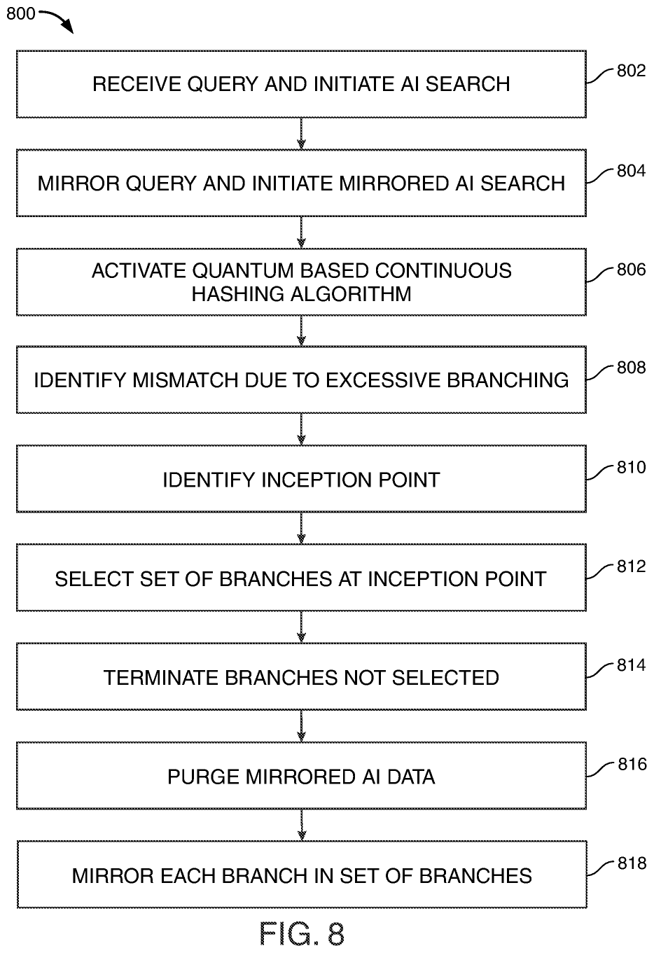

FIG. 8 shows illustrative process flow 800 for remediating excessive branching in an AI-based operation. Process flow 800 shows excessive branching in an AI-based search operation, but the steps may be applied to any suitable AI-based operation.

At 802, the system may receive a query at an AI search interface and process the query to initiate an AI search. At 804, the system may activate a mirror mode. In the mirror mode, the system may duplicate the query and initiate a mirrored AI search. In some embodiments, the system may receive the AI query at a standard processor and activate the mirror mode at a quantum processor.

At 806, the system may activate a continuous hashing algorithm. The hashing algorithm may be quantum based. The hashing algorithm may substantially continuously hash the AI search data and the mirrored AI search data and compare the hash values. At 808, the system may identify a mismatch between the hashes. The mismatch may be due to excessive branching.

At 810, the system may identify an inception point. The inception point may be the last timestamp during the search when the hash values were identical. At 812, the system may select a set of AI search branches at the inception point. The branches may be selected based on analysis of the branch outputs and the original query. The branches may be selected using an AI/ML algorithm.

At 814, the system may terminate the branches that were not selected. At 816, the system may purge the mirrored AI search data for the terminated branches. At 818, the system may mirror each branch in the set of branches at the inception point.

Thus, methods and apparatus for a QUANTUM MIRROR MODE FOR ARTIFICIAL INTELLIGENCE MODELS are provided. Persons skilled in the art will appreciate that the present invention can be practiced by other than the described embodiments, which are presented for purposes of illustration rather than of limitation, and that the present invention is limited only by the claims that follow.

What is claimed is:

1. One or more non-transitory computer-readable media storing computer-executable instructions which, when executed by a processor on a computer system, perform a method for remediating an AI hallucination at a quantum processor in a quantum information system, the quantum processor comprising a plurality of qubits, the method comprising:
receiving a data stream and executing an AI-based operation, the AI-based operation generating a first output;
mirroring the data stream and executing an AI-based mirror operation, the AI-based mirror operation generating a second output;
at a series of timestamps:
generating a hash of the first output and a hash of the second output; and
determining whether the hash of the first output is identical to the hash of the second output; and
when the hash of the first output and the hash of the second output are not identical:
pausing the AI-based operation;
identifying a latest timestamp when a hash of the first output and a hash of the second output are identical;
deleting the second output;
resuming the AI-based operation at the latest timestamp; and
mirroring the AI-based operation at the latest timestamp.

2. The media of claim 1, the computer system comprising a standard processor and a quantum processor, the method further comprising:
receiving the data stream at the standard processor;
initializing a quantum circuit at the quantum processor;
operating a hashing algorithm at the quantum circuit, the hashing algorithm configured to hash the first output and the second output substantially continuously for a duration of the AI-based operation; and
when the AI-based operation ends, collapsing the quantum circuit.

3. The media of claim 2, the quantum processor comprising N qubits, wherein N is a number between two and ten thousand and the continuous hashing algorithm utilizes a superposition property of an N-qubit processor.

4. The media of claim 1 wherein intervals in the series of timestamps are determined based at least in part on user input.

5. The media of claim 1 wherein intervals in the series of timestamps are determined using one or more artificial intelligence/machine learning algorithms.

6. The media of claim 1, the method further comprising reducing intervals between the timestamps for substantially continuous hashing.

7. The media of claim 1, the method further comprising, when the hash of the first output is not identical to the hash of the second output, using the first output to train an AI algorithm.

8. The media of claim 1 wherein mirroring the AI-based operation comprises generating a plurality of copies of the AI-based operation.

9. The media of claim 1 wherein:
the hash of the first output and the hash of the second output are not identical due to branching that exceeds a branching factor;
the latest timestamp comprises a plurality of branches;
resuming the AI-based operation at the latest timestamp comprises selecting a set of branches from the plurality of branches based at least in part on AI-based analysis of the data stream; and
mirroring the AI-based operation at the latest timestamp comprises mirroring each branch in the set of branches.

10. The media of claim 1, the quantum processor comprising a default number of quantum threads, each quantum thread comprising a default number of quantum circuits, the method further comprising automatically scaling the quantum processor, the automatic scaling comprising:
adding a quantum circuit to a quantum thread when a hashing task has a duration that is longer than a threshold duration; and
adding a quantum thread when a hashing task has a volume that is greater than a threshold volume.

11. A method for remediating an AI hallucination at a quantum processor in a quantum information system, the quantum processor comprising a plurality of qubits, the method comprising:
receiving a query and executing an AI-based search, the AI-based search returning AI-based search data;
generating a mirrored copy of the query and executing an AI-based mirrored search, the AI-based mirrored search returning AI-based mirrored search data;
using a hashing algorithm, substantially continuously hashing the search data and the mirrored search data;
at a series of timestamps, determining whether a hash of the search data is identical to a hash of the mirrored search data;
when the hash of the search data and the hash of the mirrored search data are not identical:
pausing the AI-based search;
identifying a latest timestamp when a hash of the search data and a hash mirrored search data are identical;
deleting the mirrored search data;
resuming the AI-based search at the latest timestamp; and
generating a mirrored copy of the search data at the latest timestamp.

12. The method of claim 11, the method executed by a computer system comprising a standard processor and a quantum processor, the method further comprising:
receiving the query at the standard processor;
initializing a quantum circuit at the quantum processor;
operating the hashing algorithm at the quantum circuit, the hashing algorithm for a duration of the AI-based search; and
when the AI-based search ends, collapsing the quantum circuit.

13. The method of claim 12, the quantum processor comprising N qubits, wherein N is a number between two and ten thousand and the hashing algorithm utilizes a superposition property of an N-qubit processor.

14. The method of claim 11, further comprising using one or more artificial intelligence/machine learning algorithms to determine whether the hash of the search data is identical to the hash of the mirrored search data.

15. The method of claim 11, further comprising generating a plurality of mirrored copies of the search data at the latest timestamp.

16. The method of claim 11 wherein:
the hash of the search data and the hash of the mirrored search data are not identical due to branching;
the latest timestamp comprises a plurality of branches;
resuming the search at the latest timestamp comprises selecting a set of branches from the plurality of branches based at least in part on AI-based analysis of the query; and
generating a mirrored copy of the search data at the latest timestamp comprises mirroring the search data for each branch in the set of branches.

17. The method of claim 11, the quantum processor comprising a default number of quantum threads, each quantum thread comprising a default number of quantum circuits, the method further comprising automatically scaling the quantum processor when generating hashes, the automatic scaling comprising:
adding a quantum circuit to a quantum thread when a processing task is detected to have a duration that is longer than a threshold duration; and
adding a quantum thread when the processing task is detected to have a volume that is larger than a threshold volume.

18. A system for remediating an AI hallucination in a quantum information system, the system comprising a quantum processor, the quantum processor comprising a plurality of qubits and configured to:
receive a data stream and execute an AI-based operation, the AI-based operation generating a first output;
mirror the data stream and execute a mirrored AI-based operation, the mirrored AI-based operation generating a second output;
using a hashing algorithm, generate a hash of the first output and a hash of the second output at a series of timestamps;
determine whether the hash of the first output is identical to the hash of the second output at each timestamp;
when the hash of the first output and the hash of the second output are not identical:
pause the AI-based operation;
identify a latest timestamp when a hash of the first output and a hash of the second output are identical;
delete the second output;
resume the AI-based operation at the latest timestamp; and
mirror the AI-based operation at the latest timestamp.

19. The system of claim 18, further comprising a standard processor, the system configured to:
receive the data stream at the standard processor;
initialize a quantum circuit at the quantum processor;
operate the hashing algorithm at the quantum circuit for a duration of the AI-based operation; and
when the AI-based operation ends, collapse the quantum circuit.

20. The system of claim 18, the quantum processor comprising N qubits, wherein N is a number between two and ten thousand and the hashing algorithm utilizes a superposition property of an N-qubit processor.
